(19) United States
(12) Patent Application Publication
(10) Pub. No.: US 2022/0076938 A1
(43) Pub. Date: Mar. 10, 2022

(54) VACUUM ULTRAVIOLET EXCIMER LAMP WITH A THIN WIRE INNER ELECTRODE

(71) Applicant: Xylem Europe GmbH, Schaffhausen (CH)

(72) Inventors: Manfred Salvermoser, Herford (DE); Nicole Brüggemann, Lage (DE); Reiner Fietzek, Herford (DE); Ralf Fiekens, Schloß Holte-Stukenbrock (DE); Uwe Kanigowski, Velbert (DE); Andre Wojciechowski, Essen (DE)

(73) Assignee: Xylem Europe GmbH, Schaffhausen (CH)

(21) Appl. No.: 17/291,163

(22) PCT Filed: Nov. 5, 2019
(86) PCT No.: PCT/EP2019/080267

§ 371 Date: May 4, 2021

(30) Foreign Application Priority Data
Nov. 5, 2018 (EP) 18204296.0

(51) Int. Cl. H01J 61/06; H01J 61/42; H01J 61/16; H01J 61/30

(52) U.S. Cl. CPC H01J 61/06; H01J 61/302; H01J 61/16; H01J 61/42

(57) ABSTRACT

A VUV excimer lamp has a dielectric tube for holding an excimer-forming gas, a first electrode disposed within the dielectric tube, and a second electrode arranged outside of the dielectric tube. The first electrode has an outer diameter less than 0.5 mm, is elongated, and includes at least one thin wire with an outer diameter between 0.02 mm and 0.4 mm. The thin wire is an elongated thin wire, and is substantially straight and defines a straight axis of elongation. A photochemical system has the VUV excimer lamp. An excimer lamp system has the VUV excimer lamp, and also has a power supply to supply AC electric power to the first electrode and the second electrode.

### CROSS-REFERENCE TO RELATED APPLICATIONS

This patent application is a U.S. National Phase Patent Application of PCT Application No. PCT/EP2019/080267, filed Nov. 5, 2019, which claims priority to European Patent Application No. EP18204296.0, filed Nov. 5, 2018, each of which is incorporated by reference herein in its entirety.

### FIELD OF THE INVENTION

The present invention relates to a VUV excimer lamp, to a photochemical ozone generator and to an excimer lamp system comprising such a VUV excimer lamp.

### BACKGROUND OF THE INVENTION

Excimer lamps are used for generating high-energy ultraviolet (VUV) radiation. The excimer emission is generated by means of silent electric& discharge in a discharge chamber filled with an excimer-forming gas. The discharge chamber has walls formed from a material transparent to ultraviolet (UV) light. A first electrode is disposed within the chamber. A second electrode is arranged outside of the chamber. Due to the electric field generated between the electrodes a discharge occurs, generating excimer molecules. When these excited molecules return to ground state, high-energy ultraviolet light is emitted.

Known excimer lamps have low wall plug efficiencies and a short lifetime. Further, arcing can occur if a certain power density is exceeded.

Accordingly, it is an objective of the present invention to provide an efficient VUV excimer lamp with an extended lifespan.

### SUMMARY OF THE INVENTION

This problem is solved by a VUV excimer lamp and by a photochemical ozone generator and an excimer lamp system which are realized by a system comprising such a VUV excimer lamp.

In the following Vacuum Ultra-Violet (VUV) radiation is used to describe the UV spectrum below 190 nm. Ultraviolet C (UV-C) is generally referred to a short wavelength (100-280 nm) radiation, which is primarily used for disinfection, inactivating microorganisms by destroying nucleic acids and disrupting their DNA, leaving them unable to perform vital cellular functions.

According to the invention, a VUV excimer lamp comprising a dielectric tube for holding an excimer-forming gas, a first electrode disposed within said tube, a second electrode arranged outside of said tube, is provided wherein said first electrode is elongated and includes a thin wire with an outer diameter of less than 0.5 mm. It was found that the efficiency of the lamp greatly improved with a thin wire electrode. The wire has advantageously a circular cross section and is of cylindrical shape. But it can also have a non-round cross section, for example rectangular. In this context the outer diameter has to be understood as the smallest dimension of the extension of the wire perpendicular to the longitudinal axis, e.g. the shortest side in case of rectangular shape. Multiple wires can be twisted together to form the electrode. The wire has an outer diameter between 0.02 mm and 0.4 mm. The outer diameter of the twisted electrode is preferably less than 0.5 mm. The electrode is preferably formed by a single elongated wire, wherein macroscopic spiral electrode shapes can be excluded.

Preferably, said elongated electrode and/or thin wire is substantially straight and defines a straight axis of elongation. The dielectric tube can have an elongated wall with cylindrical shape and it can extend linearly along the axial direction of the lamp body.

Preferably, the inner electrode has a thickness according to the following equation: (R/ro)/ln(R/ro)>8 wherein 2*R is the inner diameter of the glass tube and 2*ro the outer diameter of the inner electrode. More preferably, the inner electrode has a thickness according to the following equation: (R/ro)/ln(R/ro)>10. Due to the exponential behaviour of the electron multiplication within the gas even a difference of one with respect to prior art is considerable.

The first electrode can be physically connected to each end of the dielectric tube. In an advantageous embodiment the gas filling pressure is in a range between 300 mbar and 50 bar. In one embodiment the gas filling pressure is about 340 mbar for a dielectric tube with an outer diameter of about 16 mm.

Preferably, said gas consists essentially of Xe.

In order to reach high efficiency, said gas should contain less than about 10 ppm of impurities.

Preferably, said dielectric tube is made of quartz glass, which is transparent to VUV radiation.

In a preferred embodiment said elongated thin wire is tensioned and centred with a spring arranged on one side of the elongated thin wire. This allows to avoid shadow over the length of the lamp compared to an inner electrode helically wound over the full length around a rod and to ensure tensioning of the electrode at high temperature, which allows to keep the coaxial symmetry. The inner electrode is preferably physically connected to each end of the dielectric tube.

Further, a photochemical ozone generator with a previous described VUV excimer lamp is provided.

For another application said dielectric tube of the VUV excimer lamp can have a fluorescent coating on the in- or outside with luminescent compounds. Said coating allows generation of radiation with a predefined wavelength. Preferably, this coating is a UV fluorescent coating allowing generation of UV radiation. More preferably, this coating is a UV-C fluorescent coating. The UV-C fluorescent coating has preferably phosphorous compounds. A coating on the outside is beneficial, because it allows the use of less stable compounds and easier coating. If the coating is on the inside expensive glasses transparent to VUV radiation are not required, which reduces cost.

Furthermore, a method for installation of a VUV excimer lamp is provided with the following steps:
Providing a dielectric tube for holding an excimer-forming gas with a first electrode disposed within said tube, wherein said first electrode includes an elongated wire with an outer diameter of less than 0.5 mm which is substantially straight,
Connecting the elongated wire to a direct current source to actively heat up the lamp during installation,
Evacuating the dielectric tube and filling of the dielectric tube with the excimer forming gas,
Providing a second electrode on the outer surface of the dielectric tube.

This method allows to speed up the backing process, because the lamps internal features do not need to be heated from the outside. The elongated thin wire further improves the efficiency of the excimer lamp.

Preferably, the elongated wire has an outer diameter between 0.02 mm and 0.4 mm.

### BRIEF DESCRIPTION OF THE DRAWINGS

Preferred embodiments of the present invention will be described with reference to the drawings. In all figures the same reference signs denote the same components or functionally similar components.

FIG. 1 shows a state of the art schematic illustration of an inner electrode of a VUV excimer lamp arranged inside a dielectric and an inner electrode design according to the present invention,

FIG. 2 shows a schematic illustration of the inner electrode according to the present invention,

FIG. 3 is a graph showing an efficiency comparison between the state of the art inner electrode and the inventive electrode,

FIG. 4 shows an emission spectrum of xenon in a barrier discharge depending on the Xenon gas pressure,

FIG. 5 shows a principle arrangement of an excimer lamp with a phosphor coating on the inside of the dielectric, and

FIG. 6 shows a principle arrangement of an excimer lamp with a phosphor coating on the outside of the dielectric.

### DETAILED DESCRIPTION OF THE INVENTION

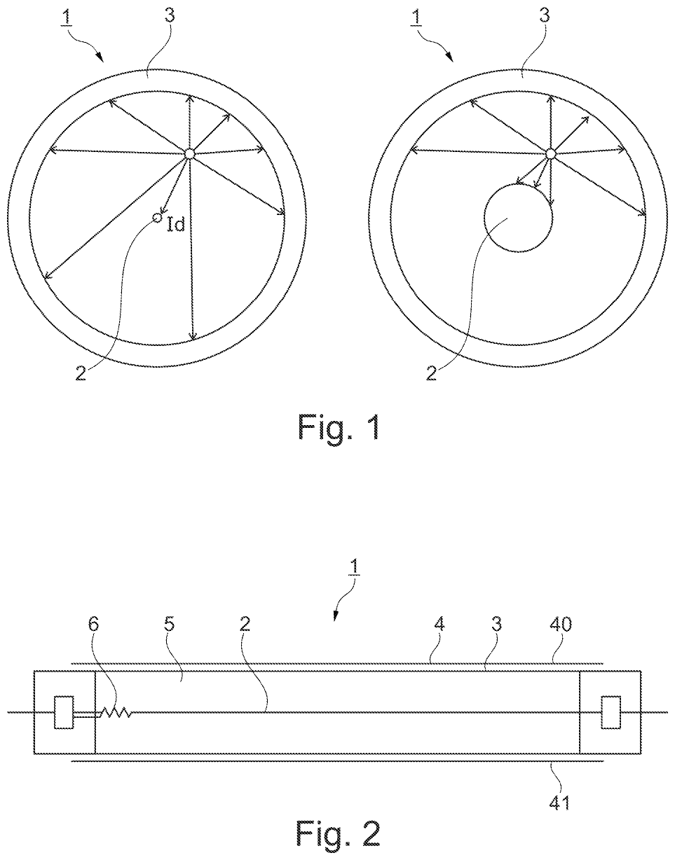

FIG. 1 shows on the right a state of the art inner electrode 2 of a VUV excimer lamp 1 within a discharge chamber formed by a dielectric 3. The inner electrode 2 is a high voltage electrode. According to the invention the inner electrode 2 is a thin wire (see FIG. 1, left) made out of a material with a high melting point, e.g. tungsten or molybdenum. The outer diameter of the inner electrode 2 d is equal or less than 0.5 mm. The wire 2 is clamped at both ends and tensioned, so that it is arranged in a straight line. Preferably, the wire is crimped tightly on both sides. By using such an electrode 2 in conjunction with a dielectric barrier, the discharge can be homogenized, which contributes to significant efficiency improvements. In addition, the thin wire electrode 2 shields and absorbs the VUV radiation to a much lower proportion than conventional wider electrodes, which leads to efficiency improvement. This is shown by the arrows indicating the generated VUV radiation.

FIG. 2 shows a side view of an excimer lamp 1 including a dielectric tube 3, a first electrode (inner electrode) 2, and a second electrode (outer electrode) 4. The first and second electrodes 2 and 4 are connected to a driving circuit (not shown). The dielectric tube 3 is made of a dielectric, which is transparent for UV radiation, for instance quartz glass. The space within the dielectric tube, between the high voltage electrode and the dielectric is filled with high purity Xenon gas 5. The water content needs to be smaller than 10 ppm for performance reasons.

The thin high voltage electrode wire 2 is tensioned and centered by means of a spring 6, attached to one end portion of the excimer lamp and to one end of the wire. The spring 6 is preferably made of an austenitic nickel-chromium-based superalloys, like Inconel. Ceramic is also applicable. The spring 6 must withstand temperatures up to 500° C. due to the baking process during lamp filling.

The dielectric 3 is surrounded by the second electrode 4 (ground electrode). This ground electrode 4 can be formed in different ways. The second electrode 4 is made of a conductive material. For instance, to form the second electrode 4, a tape or a conductive wire made of a metal (e.g., aluminum, copper) may be used. The second electrode 4 is in contact with the outer surface of the dielectric tube 3. The second electrode 4 includes linear electrodes 40, 41. The linear electrodes 40,41 are arranged substantially in parallel with each other and they extend along the longitudinal axis of the dielectric tube. In another embodiment the electrodes 4 can be formed in a spiral form on the outer surface of the dielectric tube 3. This configuration allows discharge to be generated uniformly in a circumferential direction of the dielectric tube 3, making it possible to obtain emission with more uniform distribution of brightness. Further, it is possible that the ground electrode 4 is a mesh or formed by water, which can act with minimal conductivity as electrode with a vessel being grounded.

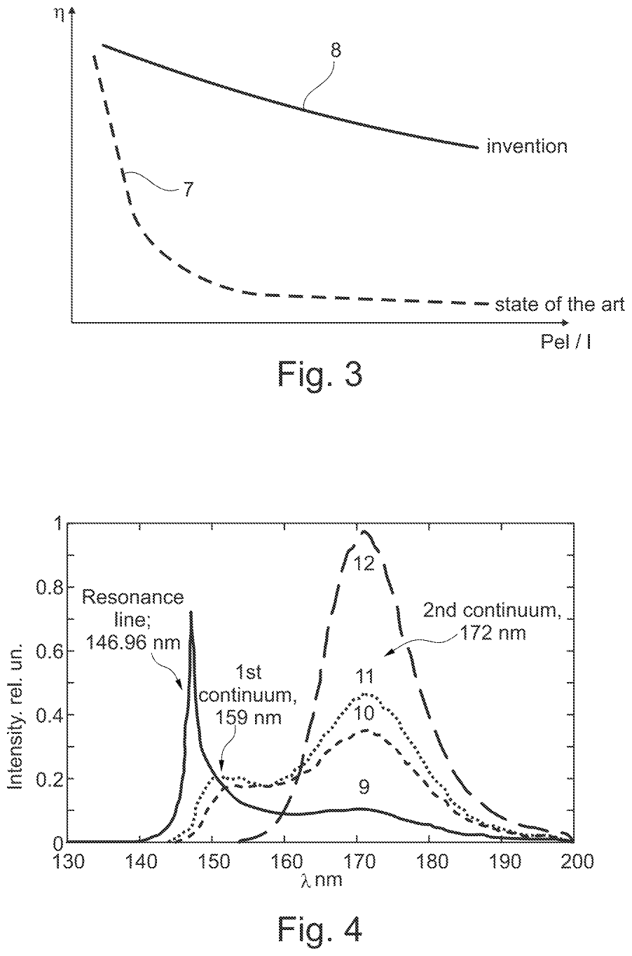

FIG. 3 shows a comparison of the lamp efficiency between a state of the art excimer lamp 1 according to FIG. 1 (right) 7 and an excimer lamp 1 with an inner electrode 2 according to the present invention (according to FIG. 1 left) 8. Surprisingly, the efficiency of the excimer lamp according to the invention 7 drops only slowly almost in a linear fashion while state of the art excimer lamps rapidly loose efficiency with increasing power input 8.

The lifetime of the lamps can be improved by increasing the gas filling pressure. FIG. 4 shows the emission spectrum of Xenon in a barrier discharge with a thin inner electrode according to the invention depending on the Xenon gas pressure. The measured pressures 49 mbar, 69 mbar, 100 mbar and 680 mbar are represented in the diagram with lines 9,10,11,12. The resonance line at 147 nm dominates at low pressures (49 mbar) 9. With increasing pressure the desired 172 nm output intensifies, while short wavelength components decrease. Below 160 nm an impact of the quartz sleeve can be seen. The efficiency of the 172 nm VUV radiation as well as the lamp lifetime improves at higher Xenon pressures.

In particular quartz tubes with an outer diameter of 16 mm and a length of 50 cm were tested. For this lamp configuration, the pressure of the gas filling should be around p_{XE}=300 mbar, preferably between 280 mbar and 370 mbar, more preferably between 300 mbar and 350 mbar. The best results for this configuration were achieved with p_{XE}=340 mbar. For other quartz tube diameters other pressures are optimal.

The emitted VUV light has a wavelength of 172 nm, which is ideal for the production of ozone. In comparison to conventional ozone generation process with the silent discharge oxygen molecules are split by photons instead of electrons. As a result, no nitrogen oxides are produced and clean Ozone in purest Oxygen feed gas can be generated. Moreover extremely high ozone concentrations can be achieved. Further, it is advantageous that there is no upper limit to the feed gas pressure used in such a photochemical ozone generator.

Another application of the VUV excimer lamp is the generation of UV-C radiation. In this case the dielectric has to be coated with a UV-C fluorescent material, e.g. a layer of phosphorus compounds like YP04: Bi. These compounds absorb the 172 nm radiation and reemit light in the UV-C range (Stokes shift). The wavelength of the emitted radiation depends on the composition of the phosphorus layer. It can be adapted to the application.

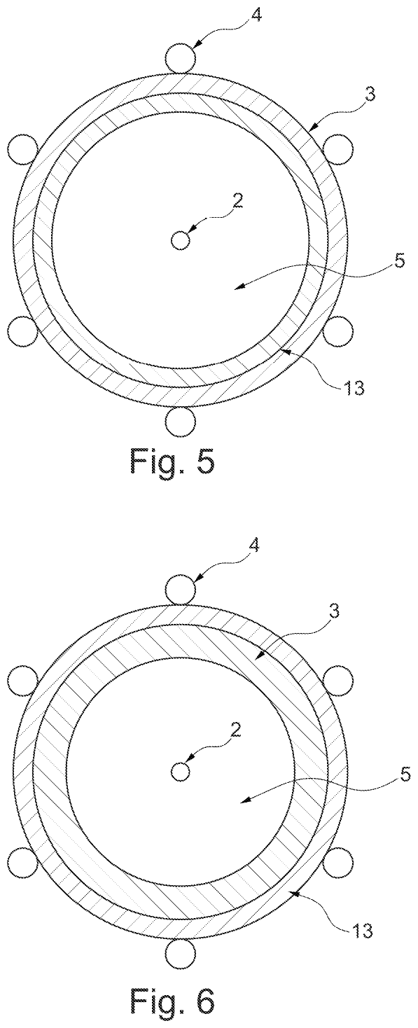

As shown in FIG. 5 the UV-C fluorescent coat 13 can be formed on an inner surface of the dielectric tube 3. Upon application of a voltage across the first and second electrodes 2 and 4 by a driving circuit, glow discharge occurs inside the dielectric tube 3, which excites the discharge medium xenon 5. When the excited discharge medium 5 makes a transition to a ground state, the discharge medium emits ultraviolet light. The ultraviolet light excites a phosphor of the phosphor layer 13, and the excited phosphor emits light in the UV-C range.

The second electrode 4 includes a plurality of linear or spiral wound electrodes arranged substantially in parallel with each other, they can be formed as a wire or strip, so that only a small section is affected by the discharge. A protecting layer of Al₂O₃ or MgO can be arranged on the inside of the UV-C fluorescent coat 13 for protecting the coat 13 from the discharge plasma. Optimizing Xenon pressure as discussed above also leads to extended durability of the phosphor coating 13.

FIG. 6 shows another embodiment with a UV-C fluorescent coat 13 arranged on the outer surface of the dielectric tube 3, between the dielectric 3 and the second electrode 4. The advantage of such an external coating is that the phosphor layer 13 has no contact with the plasma and can't be destroyed by the discharge. However, a special dielectric sleeve 3 is necessary which is able to resist as well as transmit the VUV radiation to the phosphor. Applicable is for example synthetic quartz e.g. Suprasil 310.

With phosphor coatings an efficient mercury-free UV-C lamp can be reached, which has no warm-up time, is fully dimmable (0 to 100% without loss in efficiency) while tolerating a wide range of operational temperature.

1-18. (canceled)

19. A VUV excimer lamp comprising:
a dielectric tube;
an excimer-forming gas confined within the dielectric tub;
a first elongated electrode disposed within the dielectric tube, the first electrode having a diameter of less than 0.5 mm and comprising at least one wire having an outer diameter between 0.02 mm and 0.4 mm; and
a second electrode arranged outside of the dielectric tube.

20. The VUV excimer lamp of claim 19, wherein the at least one wire defines a straight axis of elongation.

21. The VUV excimer lamp of claim 19, wherein the at least one wire comprises a twisted plurality of wires.

22. The VUV excimer lamp of claim 19, wherein the at least one wire consists of a single straight wire.

23. The VUV excimer lamp of claim 19, wherein:
the first electrode has a thickness according to the following equation:
(R/ro)/ln(R/ro)>8, where
2*R is the inner diameter of the dielectric tube, and
2*ro the outer diameter of the first electrode.

24. The VUV excimer lamp of claim 23, wherein the first electrode has a thickness according to the following equation: (R/ro)/ln(R/ro)>10.

25. The VUV excimer lamp of claim 19, wherein the dielectric tube has an elongated wall with a cylindrical shape.

26. The VUV excimer lamp of claim 19, wherein the first electrode is physically connected to each end of the dielectric tube.

27. The VUV excimer lamp of claim 19, wherein a gas filling pressure of the dielectric tube is in a range between 300 mbar and 50 bar.

28. The VUV excimer lamp of claim 27, wherein:
the gas filling pressure is in 340 mbar; and
the dielectric tube has an outer diameter of 16 mm.

29. The VUV excimer lamp of claim 19, wherein the excimer-forming gas comprises Xe.

30. The VUV excimer lamp of claim 29, wherein the excimer-forming gas consists essentially of Xe.

31. The VUV excimer lamp of claim 30, wherein the excimer-forming gas contains less than 10 ppm of impurities.

32. The VUV excimer lamp of claim 19, wherein the dielectric tube comprises quartz glass.

33. The VUV excimer lamp of claim 19, wherein:
the thin wire is tensioned and centered within the dielectric tub; and
at least one spring is arranged on at least one side of the wire.

34. The VUV excimer lamp of claim 19, wherein the dielectric tube comprises a fluorescent coating including one or more luminescent compounds on an inside or an outside of the dielectric tube.

35. The VUV excimer lamp of claim 19, wherein the dielectric tube comprises a UV fluorescent coating including one or more luminescent compounds on an inside or an outside of the dielectric tube.

36. The VUV excimer lamp of claim 35, wherein the dielectric tube comprises a UV-C fluorescent coating including one or more luminescent compounds on the inside or the outside of the dielectric tube.

37. The VUV excimer lamp of claim 36, wherein the UV-C fluorescent coating comprises one or more phosphorus compounds.

38. A Photochemical ozone generator comprising the VUV excimer lamp of claim 19.

39. An excimer lamp system comprising:
the VUV excimer lamp of claim 19, and
a power supply configured to supply AC electric power to the first electrode and the second electrode.
